(19) United States
(12) Patent Application Publication
(10) Pub. No.: US 2025/0062053 A1
(43) Pub. Date: Feb. 20, 2025

(54) WIRING MEMBER

(71) Applicant: Sumitomo Wiring Systems, Ltd., Yokkaichi-Shi, Mie (JP)

(72) Inventors: Toshinari KOBAYASHI, Yokkaichi-Shi, Mie (JP); Moriyuki SHIMIZU, Yokkaichi-Shi, Mie (JP); Kosuke UCHIDA, Yokkaichi-Shi, Mie (JP); Takashi NISHIGUCHI, Yokkaichi-Shi, Mie (JP); Hironobu YAMAMOTO, Yokkaichi-Shi, Mie (JP)

(73) Assignee: Sumitomo Wiring Systems, Ltd., Yokkaichi-Shi, Mie (JP)

(21) Appl. No.: 18/721,455

(22) PCT Filed: Dec. 2, 2022
(86) PCT No.: PCT/JP2022/044500

§ 371 Date: Jun. 18, 2024

(30) Foreign Application Priority Data
Dec. 22, 2021 (JP) 2021-208327

(51) Int. Cl. H01B 7/02

(52) U.S. Cl. CPC H01B 7/02

(57) ABSTRACT

A wiring member includes: a linear transmission member; and a resin molded portion molded with at least a portion of the linear transmission member in a direction in which the linear transmission member extends used as an insert portion, wherein the resin molded portion includes a first positioning portion trace and a second positioning portion trace located apart from each other in the direction in which the linear transmission member extends, the first positioning portion trace is a recess that extends in a direction traversing the linear transmission member, the second positioning portion trace includes a pair of partial recessed portions that extend in a direction in which the first positioning portion trace extends, and the pair of partial recessed portions are formed apart from each other at positions closest to the linear transmission member in a direction in which the pair of partial recessed portions extend.

### CROSS-REFERENCE TO RELATED APPLICATIONS

This application is the U.S. national stage of PCT/JP2022/044500 filed on Dec. 2, 2022, which claims priority of Japanese Patent Application No. JP 2021-208327 filed on Dec. 22, 2021, the contents of which are incorporated herein.

### TECHNICAL FIELD

The present disclosure relates to a wiring member.

### BACKGROUND

JP 2021-87283 discloses a wiring member including: a linear transmission member that includes a bent section; and a resin molded portion molded with a path holding portion of the linear transmission member including the bent section used as an insert portion. JP 2021-87283 discloses that the bent section is regulated by a plurality of positioning pins during the molding of the resin molded portion.

During molding, it is desired that the force supporting the linear transmission member be distributed as uniformly as possible among the plurality of positioning portions.

Therefore, the present disclosure aims to distribute the force supporting the linear transmission member as uniformly as possible among the plurality of positioning portions during molding.

### SUMMARY

A wiring member according to the present disclosure is a wiring member including: a linear transmission member; and a resin molded portion molded with at least a portion of the linear transmission member in a direction in which the linear transmission member extends used as an insert portion, wherein the resin molded portion includes a first positioning portion trace and a second positioning portion trace located apart from each other in the direction in which the linear transmission member extends, the first positioning portion trace is a recess that extends in a direction traversing the linear transmission member, the second positioning portion trace includes a pair of partial recessed portions that extend in a direction in which the first positioning portion trace extends, and the pair of partial recessed portions are formed apart from each other at positions closest to the linear transmission member in a direction in which the pair of partial recessed portions extend.

### ADVANTAGEOUS EFFECTS

According to the present disclosure, it is possible to distribute the force supporting the linear transmission member as uniformly as possible among the plurality of positioning portions.

### BRIEF DESCRIPTION OF DRAWINGS

FIG. 1 is a perspective view showing a wiring member according to a first embodiment.

FIG. 2 is a diagram illustrating a positional relationship between the wiring member and positioning portions.

FIG. 3 is an end view taken along a line III-III in FIG. 2.

FIG. 4 is an end view taken along a line IV-IV in FIG. 2.

FIG. 5 is a plan view showing the wiring member.

### DETAILED DESCRIPTION OF PREFERRED EMBODIMENTS

First, an embodiment of the present disclosure will be listed and described.

The wiring member according to the present disclosure is as follows.

A wiring member including: a linear transmission member; and a resin molded portion molded with at least a portion of the linear transmission member in a direction in which the linear transmission member extends used as an insert portion, wherein the resin molded portion includes a first positioning portion trace and a second positioning portion trace located apart from each other in the direction in which the linear transmission member extends, the first positioning portion trace is a recess that extends in a direction traversing the linear transmission member, the second positioning portion trace includes a pair of partial recessed portions that extend in a direction in which the first positioning portion trace extends, and the pair of partial recessed portions are formed apart from each other at positions closest to the linear transmission member in a direction in which the pair of partial recessed portions extend.

During molding of the resin molded portion, there may be a case where the linear transmission member is in a positional relationship in which it is strongly pressed against the positioning portion disposed in the second positioning portion trace. According to the present disclosure, the pair of partial recessed portions are formed apart from each other at the positions closest to the linear transmission member in the direction in which the pair of partial recessed portions extend. Therefore, the portion of the linear transmission member that protrudes most toward the positioning portion disposed in the second positioning portion trace is prevented from coming into contact with the positioning portion. As a result, during the molding, it is possible to prevent the linear transmission member from strongly coming into contact with the positioning portion disposed in the second positioning portion trace, and to distribute the force supporting the linear transmission member as uniformly as possible among the plurality of positioning portions.

In the wiring member according to (1), the first positioning portion trace may be provided as at least two first positioning portion traces, and the second positioning portion trace may be formed between the at least two first positioning portion trace in the direction in which the linear transmission member extends. As a result, the force supporting the linear transmission member is effectively distributed to the positioning portions disposed in at least two first positioning portion traces on both sides of the second positioning portion traces.

The wiring member according to (1) or (2), wherein the linear transmission member may include a bent section, the resin molded portion may cover the bent section, and the first positioning portion trace and the second positioning portion trace may be located on an inner circumference side of the bent section. When the positioning portion is to position the inner circumference of the bent section, the bent section may be in a positional relationship in which it is strongly pressed against the positioning portion disposed in the second positioning portion trace. In such a case, the force supporting the linear transmission member can be distributed to the plurality of positioning portions as uniformly as possible.

The wiring member according to (3), wherein the linear transmission member may include a trunk section and a first branch section and a second branch section branching from the trunk section, and the bent section may be a section where the first branch section is bent away from the second branch section. The bent section bent such that the first branch section is bent away from the second branch section may be in a positional relationship in which it is strongly pressed against the positioning portion disposed in the second positioning portion trace. In such a case, the force supporting the linear transmission member can be distributed to the plurality of positioning portions as uniformly as possible.

The wiring member according to (4), wherein the trunk section may include a first electrical wire, a second electrical wire, and a trunk sheath that covers the first electrical wire and the second electrical wire, the first branch section may include the first electrical wire, the second branch section may include the second electrical wire and a branch-side sheath that covers the second electrical wire, and the resin molded portion may cover the first electrical wire so as to be in direct contact with the first electrical wire in the bent section of the first branch section.

As a result, when the resin molded portion is in contact with the first electrical wire in the bent section of the first branch section, the positioning portion disposed in the second positioning portion trace is prevented from being strongly pressed against the first electrical wire.

The wiring member according to any one of (3) to (5), wherein the second positioning portion trace may be located closer to a center of the bent section in a direction in which the bent section extends than the first positioning portion trace.

A portion of the bent section near the center thereof in the direction in which the bent section extends may be in a positional relationship in which it is strongly pressed against the positioning portion. In such a case, the force supporting the linear transmission member can be distributed to the plurality of positioning portions as uniformly as possible.

### DETAILS OF EMBODIMENT ACCORDING TO PRESENT DISCLOSURE

Specific examples of the wiring member according to the present disclosure will be described below with reference to the drawings. Note that the present disclosure is not limited to these examples, but is indicated by the scope of the claims, and is intended to include all changes within the meaning and scope equivalent to the scope of the claims.

### First Embodiment

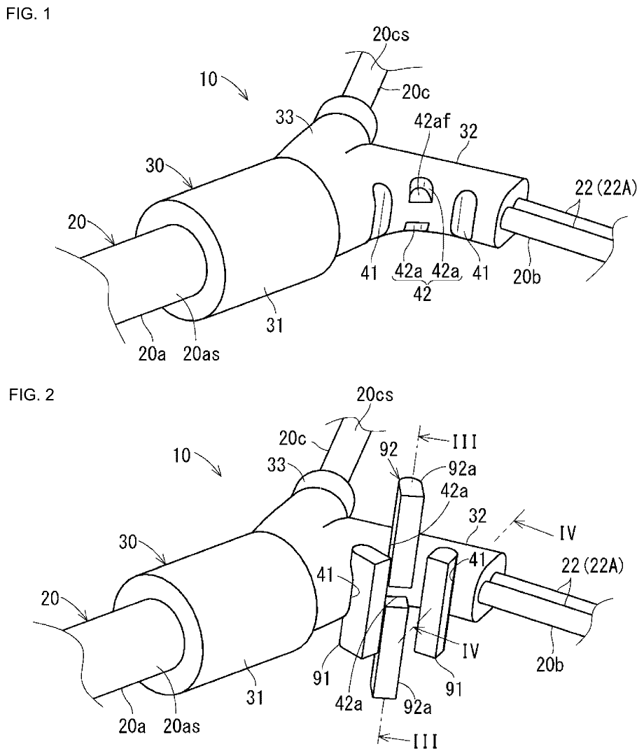

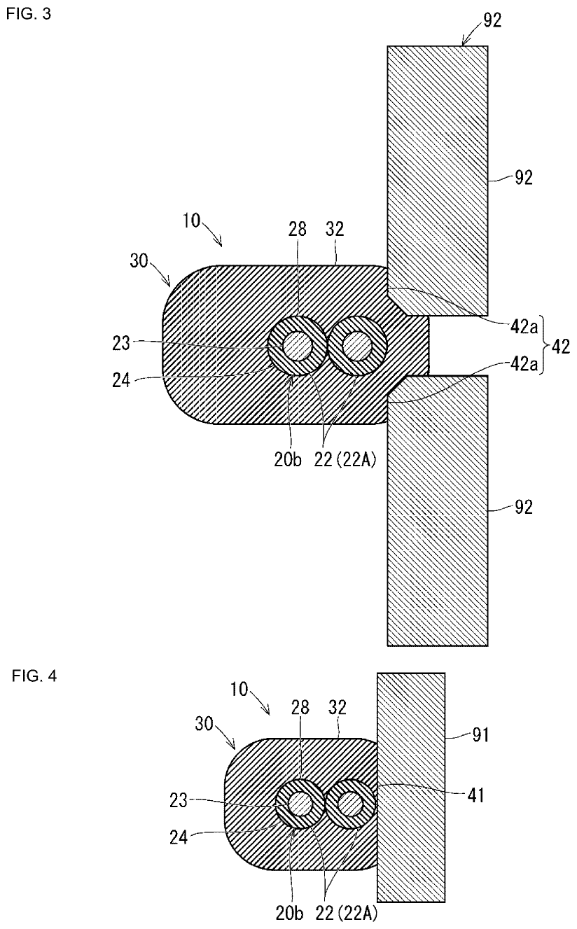

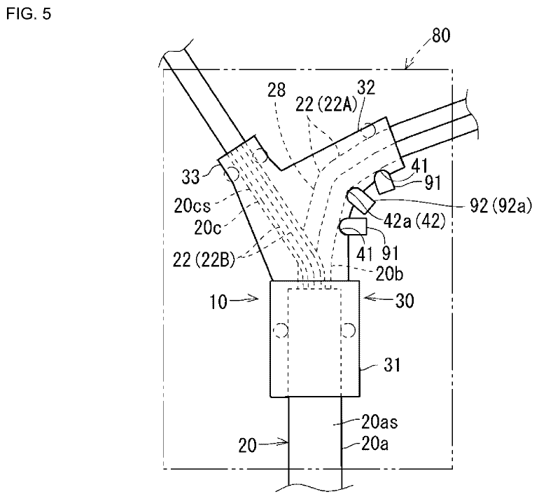

The wiring member according to an embodiment will be described below. FIG. 1 is a perspective view showing a wiring member 10. FIG. 2 is a diagram illustrating a positional relationship between the wiring member 10 and positioning portions 91 and 92. FIG. 3 is an end view taken along a line III-III in FIG. 2, and FIG. 4 is an end view taken along a line IV-IV in FIG. 2. FIG. 5 is a plan view showing the wiring member 10. In FIG. 5, the positions of a mold 80 and positioning portions 90, 91, and 92 for forming the wiring member 10 are illustrated.

The wiring member 10 includes a linear transmission member 20 and a resin molded portion 30.

The linear transmission member 20 is a linear member that transmits electricity or light. Here, the linear transmission member 20 includes electrical wires 22. Each electrical wire 22 includes a core wire 23 and a coating 24. The core wire 23 is a linear member made from a metal wire of copper, copper alloy, aluminum, aluminum alloy, or the like. The core wire 23 may be a single wire or a twisted wire in which a plurality of wires are twisted together. The coating 24 is an insulating part that covers around the core wire 23. The coating 24 is formed, for example, by extrusion-coating resin around the core wire 23. The linear transmission member may include an optical fiber that transmits an optical signal.

The linear transmission member 20 may include only a single electrical wire 22, or a plurality of electrical wires 22. Here, the linear transmission member 20 includes a plurality of (in this example, two) electrical wires 22. In the following description, the plurality of electrical wires 22 may be distinguished between a first electrical wire 22A and a second electrical wire 22B.

The electrical wires 22 may be signal lines or power lines. For example, when the wiring member 10 is mounted in a vehicle, the electrical wires 22 may be power lines that supply power to an EPB (Electric Parking Brake) or an EMB (Electro-Mechanical Brake). For example, when the wiring member 10 is mounted in a vehicle, the electrical wires 22 may be signal lines that each transmit a signal from a sensor for detecting the speed of a wheel in an ABS (Anti-Lock Brake System). The wiring member may be used as a composite harness that includes a plurality of types of electric wires. When the wiring member includes an electrical wire that serves as a power line and an electrical wire that serves as a signal line as described above, the wiring member is a composite harness. For example, the first electrical wire 22A may be thicker than the second electrical wire 22B, and the first electrical wire 22A may be a power line and the second electrical wire 22B may be a signal line. In particular, when the wiring member 10 includes a power line for an electric brake and a signal line for detecting the vehicle speed, the wiring member is a composite harness for braking. For example, the first electrical wire 22A may be a power line for an electric brake and the second electrical wire 22B may be a signal line for detecting a vehicle speed. In this case, for example, there are two first electrical wires 22A and two second electrical wires 22B.

In this embodiment, the linear transmission member 20 includes a trunk section 20a, a first branch section 20b, and a second branch section 20c. The trunk section 20a includes the first electrical wires 22A, the second electrical wires 22B, and a trunk sheath 20as that covers the first electrical wires 22A and the second electrical wires 22B. The trunk sheath 20as keeps the first electrical wires 22A and the second electrical wires 22B in a bundled state and protects them from the outside.

The first electrical wires 22A and the second electrical wires 22B are branched at the end of the trunk section 20a. The first branch section 20b is the section that includes the first electrical wires 22A, and the second branch section 20c is the section that includes the second electrical wires 22B. The second branch section 20c further includes a branch-side sheath 20cs that covers the second electrical wires 22B. The branch-side sheath 20cs keeps the plurality of second electrical wires 22B in a bundled state and protects them from the outside.

An end portion of the trunk section 20a on the opposite side from the first branch section 20b and the second branch section 20c is led into the interior of the vehicle body and connected to an ECU (Electronic Control Unit) or the like, for example. The first branch section 20b and the second branch section 20c branch and take different routes to electrical components located at different positions, such as an electric brake and a vehicle speed detection sensor. Note that it is not essential that the linear transmission member be branched. In addition, the number of linear transmission members included in the wiring member may be any number, and may be one.

It is assumed that at least one of the linear transmission members 20 is disposed along a curved route in a vehicle or the like. Therefore, the linear transmission member 20 includes a bent section 28 (see FIG. 5). Here, the bent section 28 is a section where the first electrical wires 22A in the first branch section 20b are bent. More specifically, the first branch section 20b and the second branch section 20c are directed away from each other with respect to an extension of the trunk section 20a.

The second branch section 20c is bent at the steepest angle mainly at the boundary between the trunk section 20a and the second branch section 20c. In the first branch section 20b, the entire range that extends from the trunk section 20a and covered by the resin molded portion 30 is bent as the bent section 28. As a result, the first branch section 20b is drawn out in a direction that makes a larger angle to the extension of the trunk section 20a than the second branch section 20c. The bending paths of the above-described first branch section 20b and second branch section 20c are determined based on the positions of the electrical components to which they are to be connected, and the layout of peripheral components in which the wiring member 10 is to be disposed.

The resin molded portion 30 is a portion that is molded with at least a portion of the linear transmission member 20 in the extension direction thereof used as an insert portion. In the present embodiment, the resin molded portion 30 covers the bent section 28.

More specifically, the resin molded portion 30 includes a trunk cover portion 31, a first branch cover portion 32, and a second branch cover portion 33. The trunk cover portion 31 extends linearly and covers the end portion of the trunk section 20a closer to the first branch section 20b and the second branch section 20c. The first branch cover portion 32 is continuous with an end portion of the trunk cover portion 31, and covers the end portion of the first branch section 20b closer to the trunk section 20a. More specifically, the first branch cover portion 32 covers the bent section 28 of the first branch section 20b. The second branch cover portion 33 is continuous with an end portion of the trunk cover portion 31, and covers the end portion of the second branch section 20c closer to the trunk section 20a.

As a result of the first branch cover portion 32 and the second branch cover portion 33 continuously extending from the trunk cover portion 31, the directions in which the first branch section 20b and the second branch section 20c branch from the trunk section 20a are regulated. As a result of the first branch cover portion 32 covering the bent section 28, the path of the bent section 28 is kept constant. The second branch cover portion 33 covers the second electrical wires 22B with the branch-side sheath 20cs being interposed therebetween. In contrast, the first branch cover portion 32 covers the first electrical wires 22A such that the first branch cover portion 32 is in direct contact with the outer circumferential surfaces of the first electrical wires 22A in the bent section 28.

Consider molding the resin molded portion 30 using a portion of the above-described linear transmission member 20 as an insert portion (see FIG. 5). In this case, with the paths of the trunk section 20a, the first branch section 20b, and the second branch section 20c regulated in the mold 80, molten resin is poured around the linear transmission member 20 to mold the resin molded portion 30.

The positioning portions 90, 91, and 92 for regulating the paths are provided upright within the mold 80 in the form of positioning pins, for example. With the paths of the trunk section 20a, the first branch section 20b, and the second branch section 20c regulated in the mold 80, molten resin is poured around the linear transmission member 20 to mold the resin molded portion 30.

The positioning portions 90, 91, and 92 are provided in areas covered with resin at positions where they can regulate the paths of the trunk section 20a, the first branch section 20b, and the second branch section 20c. Focusing on the first branch section 20b, the first branch section 20b includes the bent section 28. The bent section 28 is maintained in a bent state such that the positions on the outer circumference side of both end portions thereof in the direction in which the bent section 28 extends are regulated and the position on the inner circumference side of the intermediate portion thereof in the direction in which the bent section 28 extends is regulated. In the present embodiment, the position of the end portion of the bent section 28 on the trunk section 20a side is regulated by using the trunk section 20a as a path. The position of the outwardly extending end portion of the bent section 28 is regulated by the positioning portion 90. The position of the intermediate portion of the bent section 28 in the direction in which the bent section 28 extends is regulated by positioning portions 91 and 92.

As described above, the path of the linear transmission member 20 is regulated by the plurality of positioning portions 90, 91, and 92. Depending on the mode in which the paths are regulated by the positioning portions 90, 91, and 92, it is conceivable that the linear transmission member 20 is strongly pressed against one or more positioning portions of the plurality of positioning portions 90, 91, and 92.

In the case of the above example, the bent section 28 is maintained in a bent state such that both end portions of the bent section 28 in the direction in which the bent section 28 extends are regulated from the outer circumference side of the bent path, and the position of the intermediate portion of the bent section 28 in the direction in which the bent section 28 extends is regulated from the inner circumference side of the bent path. Therefore, it is conceivable that the intermediate portion of the bent section 28 in the direction in which the bent section 28 extends is strongly pressed against one or more positioning portions of the positioning portions 91 and 92.

In the present embodiment, for the mold 80 for molding the linear transmission member 20, the plurality of positioning portions 90, 91, and 92 include the first positioning portions 91 and the second positioning portions 92. The first positioning portions 91 and the second positioning portions 92 are located apart from each other in the direction in which the linear transmission member 20 extends. Therefore, the first positioning portions 91 and the second positioning portions 92 determine different positions in the direction in which the linear transmission member 20 extends.

The first positioning portions 91 extend in a direction traversing the linear transmission member 20. The second positioning portions 92 include a pair of partial positioning portions 92a extending in the direction in which the first positioning portions 91 extend. The pair of partial positioning portions 92a are respectively formed in an upper mold and a lower mold, for example. The pair of partial positioning portions 92a are located apart from each at the positions closest to the linear transmission member 20 in the direction in which the pair of partial positioning portions 92a extend. For example, it is assumed that two first electrical wires 22A are lined up in a direction orthogonal to the direction in which the pair of partial positioning portions 92a extend. The first electrical wire 22A on the side closer to the pair of partial positioning portions 92a has a circular cross section. The pair of partial positioning portions 92a are apart from each other so as to have a gap on the extension from the central axis of the first electric wire 22A to the pair of partial positioning portions 92a. When the linear transmission member 20 is observed from the second positioning portions 92, the central axis of the linear transmission member 20 (here, the minimum inclusion circle surrounding the plurality of first electric wires 22A) can be observed in the gap between the partial positioning portions 92a.

This configuration may be understood as a configuration in which the portion where the linear transmission member 20 is most strongly pressed against the second positioning portions 92 is removed when it is assumed that the linear transmission member 20 is strongly pressed against the second positioning portions 92 due to the positional relationship of the first positioning portions 91 and the second positioning portions 92 with respect to the linear transmission member 20. Thus, the linear transmission member 20 is pressed against the first positioning portions 91 and the second positioning portions 92 as uniformly as possible.

First positioning portion traces 41 are formed in the resin molded portion 30 as traces of the first positioning portions 91. The first positioning portion traces 41 are recesses extending in a direction traversing the linear transmission member 20. In the present embodiment, the surface of each first positioning portion 91 on the linear transmission member 20 side has a semi-cylindrical circumferential surface shape, and the first positioning portion trace 41 is a groove having a U-shaped cross section. The first positioning portion traces may be holes.

A second positioning portion traces 42 are formed in the resin molded portion 30 as traces of the second positioning portions 92. The second positioning portion traces 42 include a pair of partial recessed portions 42a extending in the direction in which the first positioning portion traces 41 extend. The pair of partial recessed portions 42a are located apart from each at the positions closest to the linear transmission member 20 in the direction in which the pair of partial recessed portions 42a extend. In the present embodiment, the surface of each second positioning portion 92 on the linear transmission member 20 side has a semi-cylindrical circumferential surface shape. Each of the pair of partial recessed portions 42a is a groove with a U-shaped cross section. The end portions of the pair of partial recessed portions 42a that are closer to each other are closed by end surfaces 42af. A resin portion that is a portion of the resin molded portion 30 exists between the end surfaces 42af. The corner portions of the partial positioning portions 92a may be chamfered (see FIG. 3). The pair of partial recessed portions may be bottomed holes.

In the present embodiment, at least two first positioning portions 91 are used to position the linear transmission member 20 on both sides of the second positioning portions 92. Thus, the force can be distributed to both sides of the second positioning portions 92, and the linear transmission member 20 can be positioned by at least two first positioning portions 91.

At least two first positioning portions 91 are used, and therefore the resin molded portion 30 includes at least two (in this example, two) first positioning portion traces 41. In addition, in the direction in which the linear transmission member 20 extends, the second positioning portion traces 42 are formed between at least two (in this example, two) first positioning portion traces 41.

In the present embodiment, the first positioning portions 91 and the second positioning portions 92 are located on the inner peripheral side of the bent section 28. Therefore, the force that presses the bent section 28 toward the inner circumference side can be received by the first positioning portions 91 and the second positioning portions 92 in a distributed manner.

The first positioning portions 91 and the second positioning portions 92 are located on the inner circumference side of the bent section 28, and therefore, the first positioning portion traces 41 and the second positioning portion traces 42 are located on the inner circumference side of the bent section 28 in the first branch cover portion 32.

It is conceivable that the force pressing the bent section 28 toward the inner circumference side becomes stronger near the center of the bent section 28 in the direction in which the bent section 28 extends. Therefore, it is preferable that the second positioning portions 92 are located closer to the center of the bent section 28 in the direction in which the bent section 28 extends than the first positioning portions 91. When at least two first positioning portions 91 are used, if the second positioning portions 92 are located near the center of the bent section 28 in the direction in which the bent section 28 between at least two first positioning portions 91, the force that tends to cause the bent section 28 to move toward the inner circumference side is received by at least two first positioning portions 91 and the second positioning portions 92 as uniformly as possible.

Due to the above positional relationship, the second positioning portion traces 42 are located closer to the center of the bent section 28 in the direction in which the bent section 28 extends than the first positioning portion traces 41. Note that the center of the bent section 28 in the direction in which the bent section 28 extends is the center within the bendable range of the bent section 28, and for example, is the center within the range between the boundary between the trunk section 20a and the first branch section 20b and the boundary between the bent section 28 and the linear extension portion adjacent thereto.

Note that during the molding, the linear transmission member 20 is positioned by the plurality of positioning portions 90, 91, and 92. Depending on the bending tendency of the linear transmission member 20 itself, the content of the work to be performed to set the linear transmission member 20 to the mold 80, or the like, the linear transmission member 20 may not come into contact with all of the plurality of positioning portions 90, 91, and 92.

Therefore, in the first positioning portion traces 41 and the second positioning portion traces 42 including the pair of partial recessed portions 42a, the first electrical wires 22A may be partially exposed, or may not be exposed.

Note that the positioning portions 90 may be located at any positions. Although traces of the positioning portions 90 are also formed on the resin molded portion 30, they are not shown in each figure.

In the wiring member 10 with the above-described configuration, the pair of partial recessed portions 42a are formed apart from each other in the direction in which the partial recessed portions 42a extend at the positions closest to the linear transmission member 20. Therefore, during the molding, the portion of the linear transmission member 20 that is located closest to the second positioning portions 92 is prevented from coming into contact with the pair of partial positioning portions 92a located in the pair of partial recessed portions 42a. As a result, it is possible to distribute the force supporting the linear transmission member 20 as uniformly as possible among the plurality of positioning portions 91 and 92.

In addition, as a result of being able to distribute the force supporting the linear transmission member 20 as uniformly as possible among the plurality of positioning portions 91 and 92, it is possible to suppress the occurrence of defective products.

In addition, at least two first positioning portion traces 41 are provided, and, in the direction in which the linear transmission member 20 extends, the second positioning portion traces 42 are formed between at least two first positioning portion traces 41. Therefore, the force supporting the linear transmission member 20 is effectively distributed to the first positioning portions 91 disposed in at least two first positioning portion traces 41 on both sides of the second positioning portion traces 42.

In addition, when the resin molded portion 30 covers the bent section 28, it is conceivable that the positional relationship is such that the inner circumference side of the bent section 28 is strongly pressed against the second positioning portions 92 disposed in the second positioning portion traces 42. In such a case, the force supporting the linear transmission member 20 on the inner circumference side of the bent section 28 can be distributed to the plurality of positioning portions 91 and 92 as uniformly as possible.

In particular, when the first branch section 20b includes a bent section 28 that is bent in a direction away from the second branch section 20c, it is conceivable that the bent section 28 is bent with a small radius of curvature. In such a case, the bent section 28 is likely to be pressed against the positioning portions 91 and 92 on the inner circumference side of the bent section 28 with a large force. In such a case, the force supporting the linear transmission member 20 on the inner circumference side of the bent section 28 can be effectively distributed to the plurality of positioning portions 91 and 92 as uniformly as possible.

When the first branch section 20b does not include a sheath, the resin molded portion 30 covers the first electrical wires 22A in direct contact therewith. In this case, it is conceivable that the second positioning portions 92 come into direct contact with the first electrical wires 22A. In such a case, the second positioning portions 92 disposed in the second positioning portion traces 42 are prevented from being strongly pressed against the first electrical wires 22A.

In addition, a portion of the bent section 28 near the center thereof in the direction in which the bent section 28 extends may be in a positional relationship in which it is strongly pressed against the second positioning portions 92. In such a case, the force supporting the linear transmission member 20 can be distributed to the first positioning portions 91 and the second positioning portions 92 as uniformly as possible.

### MODIFICATIONS

The above-described first positioning portion traces and the second positioning portion traces may be formed on the outer circumference side of the bent section. The linear transmission member may be provided on a linearly extending portion. It is not essential that the linear transmission member be branched.

Note that the configurations described in the above embodiment and modifications can be combined as appropriate as long as they do not contradict each other.

1. A wiring member comprising:
a linear transmission member; and
a resin molded portion molded with at least a portion of the linear transmission member in a direction in which the linear transmission member extends used as an insert portion,
wherein the resin molded portion includes a first positioning portion trace and a second positioning portion trace located apart from each other in the direction in which the linear transmission member extends,
the first positioning portion trace is a recess that extends in a direction traversing the linear transmission member,
the second positioning portion trace includes a pair of partial recessed portions that extend in a direction in which the first positioning portion trace extends, and
the pair of partial recessed portions are formed apart from each other at positions closest to the linear transmission member in a direction in which the pair of partial recessed portions extend.

2. The wiring member according to claim 1,
wherein the first positioning portion trace is provided as at least two first positioning portion traces, and
the second positioning portion trace is formed between the at least two first positioning portion trace in the direction in which the linear transmission member extends.

3. The wiring member according to claim 1,
wherein the linear transmission member includes a bent section,
the resin molded portion covers the bent section, and
the first positioning portion trace and the second positioning portion trace are located on an inner circumference side of the bent section.

4. The wiring member according to claim 3,
wherein the linear transmission member includes a trunk section and a first branch section and a second branch section branching from the trunk section, and
the bent section is a section where the first branch section is bent away from the second branch section.

5. The wiring member according to claim 4,
wherein the trunk section includes a first electrical wire, a second electrical wire, and a trunk sheath that covers the first electrical wire and the second electrical wire,
the first branch section includes the first electrical wire,
the second branch section includes the second electrical wire and a branch-side sheath that covers the second electrical wire, and
the resin molded portion covers the first electrical wire so as to be in direct contact with the first electrical wire in the bent section of the first branch section.

6. The wiring member according to claim 3, wherein the second positioning portion trace is located closer to a center of the bent section in a direction in which the bent section extends than the first positioning portion trace.

7. The wiring member according to claim 2,
wherein the linear transmission member includes a bent section,
the resin molded portion covers the bent section, and
the first positioning portion trace and the second positioning portion trace are located on an inner circumference side of the bent section.

8. The wiring member according to claim 4, wherein the second positioning portion trace is located closer to a center of the bent section in a direction in which the bent section extends than the first positioning portion trace.

9. The wiring member according to claim 5, wherein the second positioning portion trace is located closer to a center of the bent section in a direction in which the bent section extends than the first positioning portion trace.
